(19) United States
(12) Patent Application Publication
(10) Pub. No.: US 2009/0069465 A1
(43) Pub. Date: Mar. 12, 2009

(54) Intrinsically viscous hardenable mixtures, method for the production thereof, and use of the same

(75) Inventors: Bertold Austrup, Nordkirchen (DE); Gunter Ott, Munster (DE); Hubert Baumgart, Munster (DE); Karl-Heinz Joost, Drensteinfurt (DE)

Correspondence Address: BASF CORPORATION;Patent Department, 1609 BIDDLE AVENUE, MAIN BUILDING, WYANDOTTE, MI, 48192, US

(73) Assignee: Basf Coatings Aktiengsellschaft, Munster (DE)

(21) Appl. No.: 11/719,236

(22) PCT Filed: Dec. 8, 2005
(86) PCT No.: PCT/EP05/56687

§ 371 Date: May 14, 2007

(30) Foreign Application Priority Data
Dec. 17, 2004 (DE) 102004060966.7

(51) Int. Cl. C08L 1/08; C08L 75/00; C08L 3/04; C08K 5/21

(52) U.S. Cl. 524/35; 524/507; 524/216; 524/53

(57) ABSTRACT

Pseudoplastic curable mixtures comprising
(A) at least one reaction product of
   (a1) at least one reaction product of
   (a11) at least one olefinically unsaturated carboxylic acid with
   (a12) at least one glycidyl ester of an unsaturated carboxylic acid
      (a121) with
   (a2) at least one polyisocyanate
   having an epoxide group (calculated as M=42 daltons) content <0.2% by weight and an acid number <10 mg KOH/g and also
(B) at least one rheology control additive,
   process for preparing them, and their use.

The present invention relates to new pseudoplastic curable mixtures. The present invention also relates to a new process for preparing pseudoplastic curable mixtures.

The present invention relates not least to the use of the new pseudoplastic curable mixtures and of the pseudoplastic curable mixtures prepared by the new process for producing sheets and shaped parts and also as coating materials, adhesives and sealants for producing coatings, adhesive layers and seals.

Coating materials curable thermally and with UV radiation (i.e., dual-curable coating materials) which comprise reaction products (A) of 3-acryloyloxy-2-hydroxypropyl methacrylate and polyisocyanates and also unspecified thickeners (B) are known from German patent application DE 198 60 041 A1. The coating materials cure very rapidly and give coatings which
are insensitive to mechanical stress such as tension, elongation, impact or abrasion,
are resistant to moisture (e.g., in the form of water vapor), solvents and dilute chemicals, and
are resistant to environmental effects such as temperature fluctuation and UV radiation, and
exhibit high gloss and
exhibit good adhesion to a wide variety of substrates.

In practice it has been found, however, that the known coatings leave something to be desired in their condensation resistance. This is a problem especially when new vehicles are dispatched packed in protective films or transit films. The condensation that may collect beneath the films can permanently damage the new finishes, especially when additional effects are added in, such as heat and solar radiation in high summer. Such damage is extremely irksome to customers most particularly in the case of new vehicles.

Furthermore, it has become apparent that the flow properties and in particular the run stability, i.e., the propensity toward running, of the known coating materials must be further improved. Both properties, indeed, have a decisive influence on the overall visual appearance of the coatings.

“Running” is the term for the sagging of applied coating materials on vertical or inclined surfaces, producing an unattractive appearance in the resulting coatings. Where this run phenomenon occurs across a relatively large area, it is also called “curtaining”. In general a distinction is made between runs at edges, angles and holes (initiator points) and the extensive sagging of coatings on surfaces, which is also called “slipping”. The reason for the formation of runs may lie in an incorrect composition or in incorrect application of the coating material. The quantity indicated as the “run limit” is generally the dry film thickness of the applied coating material, in μm, above which the first runs occur following spray application of said material to a perforated, vertical metal panel (cf. in this respect also Römpp-Online 2002, “running”, “run limit” and “curtaining”).

It is an object of the present invention to provide new pseudoplastic curable mixtures suitable for producing sheets and shaped parts and also as coating materials, adhesives and sealants, or for preparing them, the coating materials possessing, in particular, outstanding flow and having an especially low propensity to form runs. The new coatings produced from them ought to continue to
be insensitive to mechanical stress such as tension, elongation, impact or abrasion,
be resistant to moisture (e.g., in the form of water vapor), solvents and dilute chemicals, and
be resistant to environmental effects such as temperature fluctuation and UV radiation, and
exhibit high gloss and
exhibit good adhesion to a wide variety of substrates
   but ought to be significantly improved in their condensation resistance and their flow.

Found accordingly have been the new, pseudoplastic, curable mixtures which comprise
(A) at least one reaction product of
   (a1) at least one reaction product of
   (a11) at least one olefinically unsaturated carboxylic acid with
   (a12) at least one glycidyl ester of an unsaturated carboxylic acid
      (a121) with
   (a2) at least one polyisocyanate
   having an epoxide group (calculated as M=42 daltons) content <0.2% by weight and an acid number <10 mg KOH/g and also
(B) at least one rheology control additive
   and are referred to below as “mixtures of the invention”.

Also found has been the new process for preparing pseudoplastic curable mixtures, which comprises mixing the constituents (A) and (B) and also, where appropriate, at least one further constituent (C) with one another and homogenizing the resulting mixtures and is referred to below as “process of the invention”.

Found additionally has been the new use of the mixtures of the invention for producing sheets and moldings and also coating materials, adhesives and sealants or for preparing them.

Further subject matter of the invention will emerge from the description.

In the light of the prior art it was surprising and unforeseeable for the skilled worker that the object on which the present invention was based could be achieved by means of the mixtures of the invention and the process of the invention.

In particular it was surprising that the mixtures of the invention were outstandingly suitable for producing new sheets and moldings and also as new coating materials, adhesives and sealants, in particular as new coating materials, or for preparing them.

All in all the coating materials of the invention were outstandingly suitable for producing single-coat and multicoat systems, possessing particular suitability as electrocoat materials, surfacers and primers, solid-color topcoat, basecoat and clearcoat materials for producing electrocoats, surfacer coats and antistonechip primer coats, solid-color topcoats, basecoats and clearcoats. It was surprising in this context that the coating materials of the invention exhibited outstanding flow and an especially low propensity to form runs.

The new coatings produced from the coating materials of the invention continued to
be insensitive to mechanical stress such as tension, elongation, impact or abrasion,
be resistant to moisture (e.g., in the form of water vapor), solvents and dilute chemicals, and
be resistant to environmental effects such as temperature fluctuation and UV radiation, and
exhibit high gloss and
exhibit good adhesion to a wide variety of substrates
   but were significantly improved in terms of their condensation resistance and their flow.

It was also surprising that the moldings and sheets produced from the mixtures of the invention were extraordinarily stable mechanically.

A further surprise was that the adhesive layers produced in the adhesives of the invention permanently exhibited a particularly high bond strength even under and after exposure to mechanical and chemical stress, radiation, temperature fluctuations and atmospheric humidity.

Not least the seals produced from sealants of the invention permanently sealed the sealed substrates outstandingly, even against aggressive chemicals, even under and after exposure to mechanical and chemical stress, radiation, temperature fluctuations and atmospheric humidity.

The mixtures of the invention are pseudoplastic. This means that the viscosity of the mixtures of the invention is lower at higher shear stresses or higher shear rates than at low levels (cf. Römpp Lexikon Lacke und Druckfarben, Georg Thieme Verlag, Stuttgart, N.Y., 1998, “pseudoplasticity”).

The mixtures of the invention are curable. They may be cured oxidatively, thermally and/or with actinic radiation.

Oxidative curing takes place, as is known, under the effect of atmospheric oxygen by linking of the film-forming constituents via oxygen bridges at aliphatic double bonds, accompanied by linking through polymerization (cf. Römpp Lexikon Lacke und Druckfarben, Georg Thieme Verlag, Stuttgart, N.Y., 1998, “curing”, pages 274 to 276, especially page 275, left-hand column).

The thermally curable mixtures of the invention may be self-crosslinking and/or externally crosslinking.

For the purposes of the present invention the term “self-crosslinking” refers to the capacity of a binder (regarding the term cf. Römpp Lexikon Lacke und Druckfarben, Georg Thieme Verlag, Stuttgart, N.Y., 1998, “binders”, pages 73 and 74) to undergo crosslinking reactions with itself. A prerequisite for this is that the binders already include both kinds of complementary reactive functional groups that are required for crosslinking, or reactive functional groups which react “with themselves”. Externally crosslinking mixtures of the invention, in contrast, are those in which one kind of the complementary reactive functional groups is present in the binder and the other kind is present in a curing or crosslinking agent. For further details of this refer to Römpp Lexikon Lacke und Druckfarben, Georg Thieme Verlag, Stuttgart, N.Y., 1998, “curing”, pages 274 to 276, especially page 275, bottom. Examples of suitable complementary reactive functional groups are known from patent application DE 100 42 152 A1, page 7, paragraph [0078] to page 9, paragraph [0081].

The mixtures of the invention may be curable with actinic radiation. In that case curing takes place via groups containing bonds which can be activated with actinic radiation. Actinic radiation for the purposes of the present invention means electromagnetic radiation, such as near infrared (NIR), visible light, UV radiation, X-rays or gamma radiation, especially UV radiation, and corpuscular radiation, such as electron beams, alpha radiation, beta radiation or neutron beams, especially electron beams. Examples of suitable bonds which can be activated with actinic radiation are known from patent application DE 100 42 152 A1, page 3, paragraphs [0021] to [0027].

The mixtures of the invention may be curable thermally and with actinic radiation. Where thermal curing and curing with actinic light are employed together for the mixtures of the invention, the terms “dual cure” and “dual-cure mixtures” are also used.

In addition to these curing mechanisms the mixtures of the invention may also be physically curable. For the purposes of the present invention the term “physical curing” denotes the curing of a layer of a mixture of the invention by film formation, with linking within the layer taking place by looping of the polymer molecules of the binders. Or else film formation takes place via the coalescence of binder particles (cf. Römpp Lexikon Lacke und Druckfarben, Georg Thieme Verlag, Stuttgart, N.Y., 1998, “curing”, pages 274 and 275). Physical curing accordingly may where appropriate assist the curing of the mixtures of the invention by atmospheric oxygen, by heat or by exposure to actinic radiation.

The first essential constituent of the mixtures of the invention is at least one reaction product (A) of
(a1) at least one reaction product of
   (a11) at least one olefinically unsaturated carboxylic acid with
   (a12) at least one glycidyl ester of an unsaturated carboxylic acid (a121) with
(a2) at least one polyisocyanate
   having an epoxide group (calculated as M=42 daltons) content <0.2% by weight and an acid number <10, preferably <6 and in particular <4 mg KOH/g.

For preparing the reaction product (a1) and the glycidyl esters (a12) it is basically possible to use any conventional olefinically unsaturated carboxylic acids (a11) and (a121) provided they contain no groups which in any way interfere with the reaction of the olefinically unsaturated carboxylic acid (a11) with the glycidyl ester (a12) or the reaction of the resultant reaction product (a1) with the polyisocyanate (a2), such as, for example, by inhibiting such reaction or by inducing decomposition reactions and/or side reactions such as polymerization reactions.

The olefinically unsaturated carboxylic acids (a11) and (a121) may be identical to or different from one another; preferably they are different from one another.

Preferably the olefinically unsaturated carboxylic acids (a11) and (a121) are selected from the group consisting of dicarboxylic and monocarboxylic acids; in particular they are monocarboxylic acids.

Examples of particularly suitable monocarboxylic acids (a11) and (a121) are acrylic acid, dimeric acrylic acid, methacrylic acid, crotonic acid and cinnamic acid. Especial suitability is possessed by acrylic acid and methacrylic acid. In particular the olefinically unsaturated carboxylic acid (a11) is acrylic acid and the olefinically unsaturated carboxylic acid (a121) is methacrylic acid.

One example of a particularly suitable reaction product (a1) is the reaction product of acrylic acid (a1) with glycidyl methacrylate (a12). Especially suitable reaction products (a1) of this kind contain, based in each case on their respective total amount, at least 60%, preferably at least 70% and in particular at least 80% by weight of a mixture of 3-acryloyloxy-2-hydroxypropyl methacrylate and 2-acryloyloxy-3-hydroxypropyl methacrylate.

Preferably the especially suitable reaction products (a1) include only oligomers which come about through the Michael-analogous addition of the hydroxyl groups to the double bonds, these being the principal or sole by-products. In particular they include oligomers and polymers which result from the polymerization of the epoxide groups only in amounts which are undetectable by means of the conventional detection methods of polymer chemistry.

The amount of oligomeric and polymeric constituents in the reaction products (a1) as determined by gel permeation chromatography, is preferably <40%, more preferably <30% and in particular <20% by weight, based in each case on one reaction product (a1).

Preferably the reaction of the olefinically unsaturated carboxylic acid (a11) with the glycidyl ester (a12) takes place in an equivalent ratio of 0.9:1 to 1.3:1, preferably 1.01:1 to 12:1.

Preferably the reaction is catalyzed, it being advantageous to acid a relatively small portion of the catalyst toward the end of the reaction, in order to achieve complete conversion as far as possible.

Suitable catalysts include all conventional compounds which catalyze the reaction between glycidyl compounds and carboxylic acids. Examples of suitable catalysts are tertiary amines, tertiary phosphines, ammonium compounds or phosphonium compounds, thiodiglycol, and compounds of tin, of chromium, of potassium and of cesium. Examples of highly suitable catalysts are tetrabutylammonium hydroxide, tetrabutylphosphonium bromide, trimethylbenzylammonium chloride, triethylamine, diazabicyclooctane, dimethylaminopyridine, dibutyl phosphate, triphenylphosphine, thiodiglycol, cesium chloride or tin(II) octoate, especially triphenylphosphine.

Preferably the reaction is carried out in the presence of stabilizers for acrylates and methacrylates. As well as oxygenous gas, particularly air, suitability is possessed by conventional stabilizers for preventing premature polymerization, in an amount of 0.01% to 1% by weight, preferably 0.1% to 0.5% by weight, based in each case on the amount of the olefinically unsaturated compounds. Suitable stabilizers are described for example in Houben-Weyl, Methoden der organischen Chemie, 4th edition, volume XIV/1, Georg Thieme Verlag, Stuttgart, 1961, page 433 ff. Examples of highly suitable stabilizers are sodium dithionite, sodium hydrogen sulfite, sulfur, hydrazine, phenylhydrazine, hydrazobenzene, N-phenyl-beta-naphthylamine, N-phenylethanol-diamine, dinitrobenzene, picric acid, p-nitrosodimethylaniline, diphenylnitrosamine, phenols, especially p-methoxyphenol, 2,5-di-tert-butylhydroquinone, 2,6-di-tert-butyl-4-methylphenol, p-tert-butylpyrocatechol or 2,5-di-tert-amylhydroquinone, tetramethylthiuram disulfide, 2-mercaptobenzothiazole, sodium dimethyldithio-carbamate, phenothiazine or N-oxyl compounds, such as 2,2,6,6-tetramethylpiperidine N-oxide (TEMPO) or one of its derivatives. Examples of especially suitable stabilizers are 2,6-di-tert-butyl-4-methylphenol and p-methoxyphenol and mixtures thereof.

The reaction can be carried out in the presence of an organic solvent which is inert toward the reactants (a11) and (a12) and the products and is preferably also inert toward isocyanates. Examples of suitable solvents are paint solvents, such as butyl acetate, Solventnaphtha® from Exxon-Chemie, methoxypropyl acetate or hydrocarbons such as cyclohexane, methylcyclohexane or isooctane. After the reaction the solvent may for example be removed by distillation or may remain in the reaction product (a1). Preferably the reaction is carried out in bulk, i.e., without organic solvent.

The reactants (a11) and (a12) can be reacted in any order. Preferably one reactant is introduced, the major amount of the catalyst and the stabilizer are added and then the resulting mixture is heated with stirring. The other reactant is subsequently added all at once or, preferably, is metered in gradually, during which, preferably, a constant reaction temperature is maintained.

Preferably the conversion is determined during the reaction by analysis. This can be done spectroscopically, by means of IR or NIR spectroscopy, for example. Alternatively it is possible to carry out chemical analyses on samples taken. In particular both the acid content and the epoxide content of the reaction mixture are suitable measures of the conversion. Preferably the metering and the reaction are carried out at temperatures between 60 and 140° C., preferably between 80 and 95° C.

The reaction is carried out until an epoxide group (calculated as M=42 daltons) content <0.2% by weight, in particular <0.1% by weight, and an acid number <10, preferably <6 and in particular <4 mg KOH/g have been reached. If the reaction is terminated beforehand the residual reactant content can be reduced, for example, by applying a vacuum or by passing a preferably oxygenous gas through the reaction mixture, so that the required low epoxide and acid contents are obtained. It is likewise possible to lower the epoxide content by adding small amounts of epoxide-reactive compounds, such as strong acids, butyl phosphate for example. Similarly it is possible to reduce residual acid contents by means for example of reaction with carbodiimides or aziridines.

The resulting reaction products (a1) can be immediately reacted further with the polyisocyanates (a2) to give the reaction products (A). Alternatively they can be stored and/or transported prior to their further use. Preferably the reaction products (a1) are used without further purification.

As polyisocyanates (a2) it is possible to use the polyisocyanates such as are commonly used in the paints field, in other words those known as paint polyisocyanates. These preferably have a mean isocyanate functionality of 2 to <6, in particular >2 to <6. Examples of suitable polyisocyanates (a2) are described for example in German patent application DE 100 42 152 A1, page 4, paragraph [0037] to page 6, paragraph [0063]. The isocyanate groups of the polyisocyanates (a2) can be blocked in part with conventional blocking agents, such as are described, for example, in German patent application DE 100 42 152 A1, page 6, paragraph [0062].

The reaction of the reaction products (a1) with polyisocyanates (a2) to give the reaction products (A) is preferably a urethanization. Also possible besides urethanization, for example, is an allophanatization of polyisocyanates (a2) containing oxadiazinetrione groups with reaction products (a1), in which—under appropriate analysis—carbon dioxide is released. Following the reaction of (a1) with (a2) it is possible with the resulting reaction products (A) to carry out further reactions known from polyisocyanate chemistry, such as, for example, further urethanization and/or allophanatization, biuretization, trimerization, urea formation and/or uretdionization, where appropriate with the addition of isocyanate-reactive compounds, such as hydroxyl compounds or amino compounds. In particular it is possible to block remaining free isocyanate groups with the above-described blocking agents. Additionally, it is possible to introduce hydrophilicizing groups or groups with a potentially hydrophilicizing action, such as polyoxyalkylene groups, for example, especially polyoxyethylene groups, if the reaction products (A) are to be used in aqueous mixtures of the invention.

The reaction of the reaction products (a1) with the polyisocyanates (a2) to give the reaction products (A) preferably takes place in the presence of suitable catalysts for accelerating the isocyanate addition reactions, such as tertiary amines or compounds of tin, of zinc or of bismuth, especially trimethylamine, 1,4-diazabicyclo[2.2.2]octane, bismuth octoate or dibutyltin dilaurate, which can be included in the initial charge with the reactants or metered in during the course of the reaction.

The reaction preferably takes place in the presence of stabilizers. Suitable stabilizers are those described above and also compounds which stabilize isocyanates against reactions other than those desired. Examples of suitable stabilizers of the last-mentioned kind are acids or acid derivatives, such as benzoyl chloride, phthaloyl chloride, phosphinous, phosphonous and/or phosphorous acid, phosphinic, phosphonic and/or phosphoric acid, and also the acidic esters of the last-mentioned six types of acid, sulfuric acid and its acidic esters, and/or sulfonic acids. The stabilizers can be added before, during and/or after the reaction.

The reaction can be carried out in organic solvents and/or reactive diluents which are inert toward the reactants and the products.

Examples of suitable solvents are, in particular, paint solvents such as ethyl acetate, butyl acetate, Solventnaphtha® from Exxon-Chemie as an aromatic solvent, methoxypropyl acetate, acetone and/or methyl ethyl ketone. After the end of the reaction the solvent may be removed by distillation, for example, or may remain in the reaction product (A).

Examples of suitable reactive diluents are described for example in German patent application DE 199 20 799 A1, page 7, line 56, to page 8, line 6, or in Römpp Lexikon Chemie, Georg Thieme Verlag, Stuttgart, N.Y., 10th ed., 1998, page 491.

In the reaction of the reaction products (a1) with the polyisocyanates (a2) to give the reaction products (A) it is possible for all or only some of the isocyanate groups present in the respective polyisocyanate (a2) to be reacted with the reaction product (a1).

The reaction of the reaction products (a1) with the polyisocyanates (a2) to give the reaction products (A) may be carried out continuously, in a static mixer for example, or batchwise, in a suitable stirred vessel for example. In the case of batchwise operation it is possible to include (a1) or (a2) in the initial charge and to meter in the other reactant at room temperature or elevated temperatures. Preferably the reaction is carried out at elevated temperature, in particular at 40 to 130° C., especially 60 to 80° C., the temperature range being set by heating or setting itself due to the exothermic nature of the reaction. The degree of conversion can be determined spectroscopically as described above. Alternatively samples can be taken and analyzed chemically. In particular the isocyanate content and, where appropriate, the hydroxyl content as well of the reaction mixture are suitable measures of the conversion.

The resulting reaction products (A) preferably contain <0.5% by weight, in particular <0.2% by weight of monomeric diisocyanates, based in each case on (A).

The reaction products (A) can be free from isocyanate groups, which is to say that they have an isocyanate content <0.1% by weight, preferably an isocyanate content below the detection limit.

The reaction products (A) may alternatively still contain at least one reactive functional group on average. Preferably such groups are free and/or blocked isocyanate groups. In that case the reaction products (A) preferably include a free isocyanate group (calculated as M=42 daltons) content of 0.5% to 25%, in particular 3.0% to 12.0% by weight, based in each case on (A).

With very particular preference the reaction products (A) are free from isocyanate groups.

In particular the reaction products (A) have a double bond content or a double bond density (acrylate or methacrylate groups) of at least 1, preferably at least 2, eq C═C/kg, based in each case on the nonvolatile fraction.

The amount of the reaction products (A) for use in accordance with the invention in the mixtures of the invention may vary very widely and is guided by the requirements of the case in hand. Preferably the amount is from 1% to 80%, more preferably 5% to 70%, very preferably 5% to 60% and in particular 5% to 50% by weight, based in each case on the mixture of the invention.

The further essential constituent of the mixtures of the invention is at least one rheology control additive (B). Suitable rheology control additives (B) include the conventional compounds and mixtures with which a composition, preferably a coating material, an adhesive or a sealant, in particular a coating material, can be made pseudoplastic.

Preferably the rheology control additives (B) are selected from the group consisting of urea derivatives, crosslinked polymeric microparticles, inorganic phyllosilicates, silicas, synthetic polymers containing ionic and/or associative groups, cellulose derivatives, starch derivatives, hydrogenated castor oil, overbasic sulfonates, and associative thickeners based on polyurethane.

Preferably the inorganic phyllosilicates (B) are selected from the group consisting of aluminum magnesium silicates and sodium magnesium phyllosilicates and sodium magnesium fluorine lithium phyllosilicates of the montmorillonite type; the silicas (B) from the group consisting of the nanoscale pyrogenic silicon dioxides and silicon dioxides prepared by means of the sol-gel technology; the synthetic polymers (B) from the group consisting of polyvinyl alcohol, poly(meth)acrylamide, poly(methacrylic acid), polyvinylpyrrolidone, styrene-maleic anhydride copolymers or ethylene maleic anhydride copolymers and their derivatives and also polyacrylates; and the associative thickeners (B) based on polyurethane from the group of the hydrophobically modified ethoxylated polyurethanes (cf. in this regard Römpp Lexikon Lacke und Druckfarben, Georg Thieme Verlag, Stuttgart, N.Y., 1998, “thickeners”, pages 599 to 600, and the textbook “Lackadditive” [Additives for coatings] by Johan Bieleman, Wiley-VCH, Weinheim, N.Y., 1998, pages 51 to 59 and 65).

It is preferred to use combinations of ionic and nonionic thickeners (B), as described in patent application DE 198 41 842 A1, page 4, line 45, to page 5, line 4, for the purpose of establishing a pseudoplastic behavior in the powder slurries, or to use combinations of associative thickeners (B) based on polyurethane and wetting agents based on polyurethane.

Particular preference is given to using urea derivatives (B) or mixtures (B) comprising them, as described for example in patent applications WO 94/22968, EP 0 276 501 A1, EP 0 249 201 A1, WO 97/12945, DE 199 24 170 A1, column 2, line 3, to column 7, line 24, DE 199 24 171 A1, page 2, line 44, to page 5, line 53, DE 199 24 172 A1, page 2, line 44, to page 3, line 32, DE 100 42 152 A1, page 2, paragraph [0010], to page 6, paragraph [0066], and DE 101 26 647 A1, page 2, paragraph [0009], to page 6, paragraph [0066].

The amount of the rheology control additives (B) in the mixtures of the invention may likewise vary very widely. The amount is guided by the nature of the particular rheology control additive (B) used and the extent of the pseudoplastic effect it is intended to establish. The rheology control additives (B) are preferably employed in the conventional, effective amounts described in the prior art. Generally these amounts are 0.1% to 40% and in particular 0.5% to 30% by weight, based in each case on the mixture of the invention.

The mixtures of the invention may further comprise at least one further constituent (C). Where the amounts of the essential constituents (A) and (B) do not add up to 100% by weight, the mixtures of the invention necessarily include at least one constituent (C).

Preferably the constituent (C) is selected from the group consisting of binders curable physically, thermally, with actinic radiation, and both thermally and with actinic radiation, crosslinking agents curable thermally and both thermally and with actinic radiation, low molecular mass and oligomeric reactive diluents curable thermally, with actinic radiation, and both thermally and with actinic radiation, and additives other than constituent (B).

Preferably the additive (C) is selected from the group consisting of color and/or effect pigments, molecularly dispersely soluble dyes; light stabilizers, such as UV absorbers and reversible free-radical scavengers (HALS); antioxidants; low-boiling and high-boiling (“long”) organic solvents; devolatilizers; wetting agents; emulsifiers; slip additives; polymerization inhibitors; thermal crosslinking catalysts; thermolabile free-radical initiators; adhesion promoters; flow agents; film-forming auxiliaries; flame retardants; corrosion inhibitors; free-flow aids; waxes; siccatives; biocides; and flatting agents.

Examples of suitable constituents (C) are known from patent applications DE 199 24 171 A1, page 5, line 48, to page 9, line 32, DE 100 42 152 A1, page 7, paragraph [0071], to page 11, paragraph [0093], und DE 101 54 030 A1, column 11, paragraph [0064], to column 12, paragraph [0071].

The amount of the constituents (C) in the mixtures of the invention may vary extraordinarily widely and is guided by the nature of the particular constituents (C) employed. Preferably the constituents (C) are employed in the conventional, effective amounts.

Preferably the mixtures of the invention are prepared by mixing their constituents (A) and (B) and also, where appropriate, (C) with one another and homogenizing the resulting mixtures. This is preferably done using the conventional mixing methods and apparatus such as stirred tanks, agitator mills, extruders, kneading apparatus, Ultraturrax, inline dissolvers, static mixers, micromixers, toothed-wheel dispersers, pressure relief nozzles and/or microfluidizers, preferably in the absence of actinic radiation.

The resultant mixtures of the invention are conventional mixtures comprising organic solvents, aqueous mixtures, substantially or entirely solvent-free and water-free liquid mixtures (100% systems), substantially or entirely solvent-free and water-free solid powders, or substantially or entirely solvent-free powder suspensions (powder slurries). They may also be one-component systems, in which the binders and the crosslinking agents are present alongside one another, or two-component or multicomponent systems, in which the binders and the crosslinking agents are separate from one another until shortly before application.

The mixtures of the invention have an extremely wide deversity of possible uses

Preferably they serve for producing sheets and moldings and also as coating materials, adhesives and sealants or for preparing coating materials, adhesives and sealants.

The mixtures of the invention are preferably coating materials.

With particular preference the coating materials of the invention are used as electrocoat materials, primer coats, surfacers or antistonechip primers, basecoat materials, solid-color topcoat materials and clearcoat materials for producing electrocoats, primer coats, surfacer coats or antistonechip primer coats, basecoats, solid-color topcoats and clearcoats. These coating systems may be single-coat or multicoat systems. With very particular preference they are multicoat systems and may comprise at least two coats, in particular at least one electrocoat, at least one surfacer coat or antistonechip primer and also at least one basecoat and at least one clearcoat or at least one solid-color topcoat. With particular preference the multicoat systems comprise at least one basecoat and at least one clearcoat.

It is particularly advantageous to produce the clearcoat of the multicoat systems from the mixtures of the invention. The clearcoats constitute the outermost coat of the multicoat systems, which substantially determines the overall visual appearance and protects the color and/or effect basecoats against mechanical and chemical damage and damage due to radiation. The clearcoats of the invention prove to
be insensitive to mechanical stress such as tension, elongation, impact or abrasion,
be resistant to moisture (e.g., in the form of water vapor), solvents and dilute chemicals, and
be resistant to environmental effects such as temperature fluctuation and UV radiation, and
exhibit high gloss and
exhibit good adhesion to a wide variety of substrates
   and are significantly improved in their condensation resistance and their flow.

In accordance with the intended use the mixtures of the invention are applied to conventional temporary or permanent substrates.

For the production of sheets and moldings of the invention it is preferred to use conventional temporary substrates, such as metal belts and polymeric belts or hollow bodies made of metal, glass, plastic, wood or ceramic, which can be easily removed without damaging the sheets and moldings of the invention.

Where the mixtures of the invention are used for producing coatings, adhesive layers and seals, permanent substrates are used, such as bodies of means of transport, especially motor vehicle bodies, and parts thereof, the interior and exterior of buildings and parts thereof, doors, windows and furniture, and, in the context of industrial coating, hollow glassware, coils, containers, packaging, small parts, electrical, mechanical and optical components, and components for white goods. The sheets and moldings of the invention may likewise serve as substrates.

In terms of method the application of the mixtures of the invention exhibit no special features but can instead take place by any conventional application methods suitable for the mixture in question, such as by electrocoating, fluid-bed coating, spraying, squirting, knifecoating, brushing, pouring, dipping, trickling or rolling, for example. Preference is given to employing spray application methods, except where the mixtures of the invention are powders.

The application of the powders also has no peculiarities in terms of method, but instead takes place, for example, in accordance with the conventional fluidized bed techniques such as are known, for example, from the BASF Coatings AG brochures “Pulverlacke für industrielle Anwendungen”, January 2000, or “Coatings Partner, Pulverlack Spezial”, 1/2000, or from Römpp Lexikon Lacke und Druckfarben, Georg Thieme Verlag, Stuttgart, N.Y., 1998, pages 187 and 188, “electrostatic powder spraying”, “electrostatic spraying” and “electrostatic fluidized bath process”.

In the course of application it is advisable to operate in the absence of actinic radiation, in order to prevent premature crosslinking of the mixtures of the invention.

For producing the multicoat systems it is possible to employ wet-on-wet techniques and constructions which are known, for example, from German patent application DE 199 30 067 A1, page 15, line 23, to page 16, line 36. It is a very substantial advantage of the use according to the invention that all coats of the multicoat paint systems of the invention can be produced from the mixtures of the invention.

The curing of the mixtures of the invention takes place in general after a certain rest time or flash-off time. This may have a duration of 30 s to 2 h, preferably 1 min to 1 h and in particular 1 to 45 min. The rest time serves, for example, for the flow leveling and devolatilization of the applied mixtures of the invention and for the evaporation of volatile constituents such as any solvent present. Flashing off can be accelerated by an elevated temperature, but below that which effects a cure, and/or by a reduced atmospheric humidity.

The thermal curing of the applied mixtures is effected, for example, with the aid of a gaseous, liquid and/or solid, hot medium, such as hot air, heated oil or heated rolls, or of microwave radiation, infrared light and/or near infrared (NIR) light. Heating takes place preferably in a forced-air oven or by irradiation with IR and/or NIR lamps. As in the case of the actinic radiation cure the thermal cure as well may take place in stages.

With advantage the thermal cure takes place at temperatures from room temperature to 200° C.

In the case of curing with actinic radiation it is preferred to employ a radiation dose of 103 to 3×10⁴, preferably 2×10³ to 2×10⁴, more preferably 3×10³ to 1.5×10⁴ and in particular 5×10³ to 1.2×10⁴ J m⁻². The radiation intensity is 1×10⁰ to 3×10⁵, preferably 2×10⁰ to 2×10⁵, more preferably 3×10⁰ to 1.5×10⁵ and in particular 5×10⁰ to 1.2×10⁵ W m⁻².

For the actinic radiation cure the conventional radiation sources and optical auxiliary measures are employed. Examples of suitable radiation sources are flash lamps from the company VISIT, high-pressure or low-pressure mercury vapor lamps, which may have been doped, or electron beam sources. The arrangement of these sources is known in principle and can be adapted to the circumstances of the workpiece and of the process parameters. In the case of workpieces of complex shape, such as are envisaged for automobile bodies, those regions not accessible to direct radiation (shadow regions), such as cavities, folds and other structural undercuts, can be cured using pointwise, small-area or all-round emitters, in conjunction with an automatic movement means for the irradiation of cavities or edges.

The equipment and conditions for these curing methods are described for example in R. Holmes, U.V. and E.B. Curing Formulations for Printing Inks, Coatings and Paints, SITA Technology, Academic Press, London, United Kingdom 1984, in German patent application DE 198 18 735 A1, column 10, line 31, to column 11, line 16, in R. Stephen Davidson, “Exploring the Science, Technology and Applications of U.V. and E.B. Curing”, Sita Technology Ltd., London, 1999, or in Dipi.-lng. Peter Klamann, “eltosch System-Kompetenz, UV-Technik, Leitfaden für Anwender”, page 2, October 1998. With particular preference the actinic radiation cure is carried out under an oxygen-depleted atmosphere. “Oxygen-depleted” means that the oxygen content of the atmosphere is lower than the oxygen content of air (20.95% by volume). Preferably the maximum oxygen content of the oxygen-depleted atmosphere is 18%, more preferably 16%, very preferably 14%, with particular preference 10% and in particular 6.0% by volume.

Both the thermal cure and the actinic radiation cure can be carried out in stages. These stages may take place one after another (sequentially) or simultaneously. In accordance with the invention sequential curing is of advantage and is therefore used with preference. It is particularly advantageous in this context to carry out the thermal cure after the actinic radiation cure.

The thermoset materials of the invention which result, particularly the sheets, moldings, coatings, adhesive layers and seals of the invention, are outstandingly suitable for the coating, adhesive bonding, sealing, wrapping and packaging
of means of transport of all kinds, interior and exterior, and parts thereof,
of buildings, interior and exterior, and parts thereof, and
of doors, windows and furniture, and also
in the context of industrial coating, in particular of hollow glassware, coils, containers, packaging, small parts, such as nuts, bolts, wheelrims or hubcaps, electrical components, such as windings (coils, stators, rotors), mechanical components, optical components, and components for white goods, such as radiators, household appliances, refrigerator panels or washing machine panels.

The substrates of the invention coated with coatings of the invention, bonded with adhesive layers of the invention, sealed with seals of the invention and/or wrapped or packaged with sheets and/or moldings of the invention have outstanding service properties in association with a particularly long service life.

### EXAMPLES

### Preparation Example 1

### The Preparation of a Methacrylate Copolymer (C1) for Preparing a Rheology Control Additive (B)

A suitable reactor equipped with a stirrer, two feed ports for the monomer mixture and the initiator solution, nitrogen inlet pipe, thermometer and reflux condenser was charged with 808 parts by weight of an aromatic hydrocarbons fraction having a boiling range of 158 to 172° C. and this initial charge was heated to 140° C. Thereafter, with stirring, a monomer mixture of 679 parts by weight of cyclohexyl methacrylate, 480 parts by weight of n-butyl acrylate, 335 parts by weight of 2-hydroxyethyl methacrylate and 31 parts by weight of methacrylic acid was metered into the reactor at a uniform rate over 4 hours and an initiator solution composed of 121 parts by weight of tert-butyl perethylhexanoate in 46 parts by weight of the aromatic solvent was metered into the reactor at a uniform rate over 4.75 hours. The metering of the monomer mixture was commenced 15 minutes after the start of the metering of the initiator solution. After the end of initiator metering the reaction mixture was postpolymerized at 140° C. for two hours and subsequently cooled.

The resulting solution of the methacrylate copolymer (C1) had a solids content of 66% by weight (one hour, forced-air oven/130° C.). The methacrylate copolymer (C1) had an OH number of 95 mg KOH/g solids, a glass transition temperature Tg of +22° C., a number-average molecular weight of 3336 daltons, a mass-average molecular weight of 7975 daltons and a molecular weight polydispersity of 2.4.

### Preparation Example 2

### The Preparation of a Mixture of Methacrylate Copolymer (C1) and Urea Derivative (=Rheology Control Additive B)

A 2 l glass beaker was charged with 485 parts by weight of the solution of methacrylate copolymer (C1) from Preparation Example 1, 2.24 parts by weight of ethylenediamine and 3.33 parts by weight of methoxypropylamine. A solution of 9.43 parts by weight of hexamethylene diisocyanate in 100 parts by weight of butyl acetate was metered over the course of 5 minutes into the initial charge with vigorous stirring using a laboratory dissolver. The reaction mixture was subsequently stirred intensely for 15 minutes. The resulting rheology control additive (B) had a solids content of 55%, determined in a forced-air oven (1 h at 130° C.).

### Preparation Example 3

### The Preparation of a Methacrylate Copolymer (C2) (=Binder C)

A suitable reactor equipped with a stirrer, two feed ports for the monomer mixture and the initiator solution, nitrogen inlet pipe, thermometer and reflux condenser was charged with 769 parts by weight of an aromatic hydrocarbons fraction having a boiling range of 158 to 172° C. and this initial charge was heated to 140° C. Thereafter, with stirring, a monomer mixture of 160 parts by weight of cyclohexyl methacrylate, 745 parts by weight of ethylhexyl acrylate, 433 parts by weight of hydroxyethyl methacrylate in, 240 parts by weight of 4-hydroxybutyl acrylate and 24 parts by weight of acrylic acid was metered into the reactor at a uniform rate over 4 hours and an initiator solution composed of 32 parts by weight of tert-butyl perethylhexanoate in 96 parts by weight of the aromatic solvent was metered into the reactor at a uniform rate over 4.75 hours. The metering of the monomer mixture was commenced 15 minutes after the start of the metering of the initiator solution. After the end of initiator metering the reaction mixture was postpolymerized at 140° C. for two hours and subsequently cooled.

The resulting solution of the methacrylate copolymer (C2) had a solids content of 66% by weight (one hour, forced-air oven/130° C.). The methacrylate copolymer (C2) had an OH number of 175 mg KOH/g solids, a glass transition temperature Tg of −22° C., a number-average molecular weight of 3908 daltons, a mass-average molecular weight of 10 170 daltons and a molecular weight polydispersity of 2.6.

### Preparation Example 4

### The Preparation of a Reaction Product (a1)

9290 g of glycidyl methacrylate, 70 g of triphenylphosphine and 14 g of 2,6-di-tert-butyl-4-methylphenol were charged to a suitable stirred tank. Air was passed at 5 l/h through and 10 l/h over the mixture. The mixture was heated to 70° C. with stirring. At this temperature 4710 g of acrylic acid were metered in over the course of five hours. The temperature rose at the beginning to 81° C. After the evolution of heat had subsided the reaction mixture was held at 65 to 70° C. After the end of the addition the temperature was raised to 90° C. After six hours at 90° C. a sample taken was found to have an acid number of 9.4 mg KOH/g. Subsequently a further 14 g of triphenylphosphine were added. After a further six hours at 90° C. a sample taken was found to have an acid number of 1.8 mg KOH/g. The reaction mixture was stirred at 90° C. for a further 24 hours and then its epoxide content was measured. It was 0.1% by weight.

### Preparation Example 5

### The Preparation of the Reaction Product (A1)

A reaction vessel suitable for reacting polyisocyanates, with stirrer and gas inlet tube, was charged, under air introduced at 0.3 l/h, with 1724.22 g of a polyisocyanate based on hexamethylene diisocyanate (Desmodur® XP 2410 from Bayer AG), 1155 g of butyl acetate, 4.09 g of 2,6-di-tert-butyl-4-methylphenol and 2.04 g of a tin catalyst (Desmorapid® Z from Bayer AG) and this initial charge was heated to 60° C. with stirring. At this temperature, with stirring, 2304.65 g of the reaction product (a1) from Preparation Example 4 were metered into the initial charge over two hours. The resulting reaction mixture was stirred at 60° C. for 10 hours until an isocyanate content <0.1% by weight was reached. The resulting reaction product (A1) had a solids content of 76.6% by weight.

### Preparation Example 6

### The Preparation of the Reaction Product (A2)

A reaction vessel suitable for reacting polyisocyanates, with stirrer and gas inlet tube, was charged, under air introduced at 0.3 l/h, with 1752.78 g of a polyisocyanate based on hexamethylene diisocyanate (Desmodur® N 3600 from Bayer AG), 1155 g of butyl acetate, 4.09 g of 2,6-di-tert-butyl-4-methylphenol and 2.04 g of a tin catalyst (Desmorapid® Z from Bayer AG) and this initial charge was heated to 60° C. with stirring. At this temperature, with stirring, 2336.08 g of the reaction product (a1) from Preparation Example 4 were metered into the initial charge over two hours. The resulting reaction mixture was stirred at 60° C. for 10 hours until an isocyanate content <0.1% by weight was reached. The resulting reaction product (A2) had a solids content of 75.8% by weight.

### Examples 1 and 2

### The Preparation of Clearcoat Materials 1 and 2

The clearcoat materials 1 and 2 were prepared by mixing the constituents indicated in Table 1 in the stated order and homogenizing the resulting mixtures.

TABLE 1
The physical composition of clearcoat materials 1 and 2 of
Examples 1 and 2

| | Example | |
|---|---|---|
| | (parts by weight:) | |
| Constituent | 1 | 2 |
| Stock varnish: | | |
| Binder (C2) from Preparation Example 3 | 35 | 35 |
| Rheology control additive (B) from Preparation | 15 | 15 |
| Example 2 | | |
| Reaction product (A1) from Preparation Example 5 | 20 | — |
| Reaction product (A2) from Preparation Example 6 | — | 20 |
| Further additives (C): | | |
| UV absorber (substituted hydroxyphenyltriazine) | 1.0 | 1.0 |
| HALS (N-methyl-2,2,6,6-tetramethylpiperidinyl ester) | 1.0 | 1.0 |
| Additive (Byk ® 385 from Byk Chemie) | 0.7 | 1.0 |
| Butyl acetate 98-100 | 25.8 | 25.8 |
| Irgacure ® 184 (commercial photoinitiator from | 1.0 | 1.0 |
| Ciba Specialty Chemicals) | | |
| Lucirin ® TPO (commercial photoinitiator from | 0.5 | 0.5 |
| BASF AG, based on acylphosphine oxide) | | |
| Total: | 100 | 100 |
| Crosslinking component (C): | | |
| Isocyanato acrylate Roskydal ® UA VPLS 2337 from | 22.54 | 22.54 |
| Bayer AG (basis: trimeric hexamethylene | | |
| diisocyanate; isocyanate group content: 12% | | |
| by weight) | | |
| Isocyanato acrylate Roskydal ® UA VP FWO | 5.64 | 5.64 |
| 3003-77 from Bayer AG, based on the | | |
| trimer of isophorone | | |
| diisocyanate (70.5% strength in butyl acetate; | | |
| viscosity: 1500 mPas; isocyanate group content: | | |
| 6.7% by weight) | | |
| Polyisocyanate based on isophorone | 6.6 | 6.6 |
| diisocyanate (Desmodur ® N 3300 from Bayer AG) | | |
| Butyl acetate 98-100 | 2.82 | 2.82 |
| Total: | 37.6 | 37.6 |

The clearcoat materials 1 and 2 had a very good pot life and very good application characteristics. In particular they exhibited outstanding flow and an especially low propensity to form runs, and so could be applied without problems even in high film thicknesses.

Free films, applied over polypropylene, with a film thickness of 40±10 μm, of the clearcoat materials 1 and 2 were prepared and were investigated by means of dynamic mechanical thermal analysis (DMTA) (cf. in this respect Murayama, T., Dynamic Mechanical Analysis of Polymeric Materials, Elsevier, N.Y., 1978 and Loren W. Hill, Journal of Coatings Technology, Vol. 64, No. 808, May 1992, pages 31 to 33; Th. Frey, K.-H,. Groβe Brinkhaus and U. Röckrath in Cure Monitoring Of Thermoset Coatings, Progress In Organic Coatings 27 (1996), 59-66; German patent application DE 44 09 715 A1 or German patent DE 197 09 467 C2). The films were cured by exposure to UV light with a dose of 1000 mJ cm⁻² and a radiation intensity of 83 W m⁻² using an iron-doped mercury vapor lamp from IST with a final thermal cure at 120° C. for 30 minutes. DMTA measurements were used to determine the viscoelastic parameters and the glass transition temperature Tg of the homogeneous, cured, free films under the following conditions:

| | | |
|---|---|---|
| 1. | Instrument: | DMA MK IV (Rheometric Scientific) |
| 2. | Conditions: | Tensile mode, amplitude 0.2%, frequency 1 Hz |
| 3. | Temperature ramp: | 1° C./min from room temperature to 200° C. |

The results are found in Table 2.

TABLE 2
Viscoelastic parameters and glass transition temperature Tg of
the films of clearcoat materials 1 and 2

Clearcoat
material:

| Parameter | 1 | 2 |
|---|---|---|
| Glass transition temperature (° C.) | 79 | 78 |
| Storage modulus E′ (Pa) | 10^{8.5} | 10^{8.6} |
| Loss factor tanδ at 20° C. | 0.04 | 0.04 |

### Examples 3 and 4

### The Production of White Multicoat Paint Systems 1 and 2

The white multicoat paint system of Example 3 was prepared using the clearcoat material 1 of Example 1

The white multicoat paint system of Example 4 was prepared using the clearcoat material 2 of Example 2.

To produce the multicoat paint systems 1 and 2, steel panels were coated with cathodically deposited electrocoats, baked at 170° C. for 20 minutes, in a dry film thickness of 18 to 22 μm. Subsequently the steel panels were coated with a commercial two-component water-based surfacer from BASF Coatings AG, such as is usually used for plastic substrates. The resulting surfacer films were baked at 90° C. for 30 minutes, to give a dry film thickness of 35 to 40 μm. Thereafter a commercial white aqueous basecoat material from BASF Coatings AG (snow white) was applied with a film thickness of 12 to 15 μm in each case, after which the resulting aqueous basecoat films were flashed off at 80° C. for ten minutes. Subsequently the clearcoat materials 1 and 2 were applied pneumatically in one cross pass using a flow-type cup gun in film thicknesses of 40 to 45 μm in each case.

The aqueous basecoat films and the clearcoat films 1 and 2 were cured at room temperature for 5 minutes and at 80° C. for 10 minutes, followed by irradiation with UV light in a dose of 104 J m⁻² (1000 mJ cm⁻²) with a radiation intensity of 83 W m⁻², using an iron-doped mercury vapor lamp from IST, and finally at 140° C. for 20 minutes. This gave the white multicoat paint systems 1 and 2.

Their hardness, scratch resistance, chemical resistance and weathering stability, and the gloss, were very good. Their yellowness index according to DIN 6167 immediately after baking was 1.0 unit. When the multicoat paint systems 1 and 2 were overbaked there was only a slight increase in the yellowness index. Accordingly the multicoat paint systems 1 and 2 exhibited high yellowing stability. The flow of the multicoat paint systems 1 and 2 was outstanding, as was their condensation resistance, determined by means of the conventional constant condensation climate (CCC) test.

1. A pseudoplastic curable mixture, comprising:
(A) at least one reaction product comprising the reaction product of (a1) and (a2), wherein
(a1) comprises at least one reaction products comprising the reaction, product of components (a11) and (a12), wherein
(a11) comprises at least one olefinically unsaturated carboxylic acid and
(a12) comprises at least one glycidyl ester of an unsaturated carboxylic acid (a121)
(a2) comprises at least one polyisocyanate having an epoxide group (calculated as M=42 daltons) content <0.2% by weight and an acid number <10 mg KOH/g; and
(B) at least one rheology control additive.

2. The mixture of claim 1, wherein the mixture is curable thermally, with actinic radiation, or with a combination thereof.

3. The mixture of in claim 1, wherein the olefinically unsaturated carboxylic acids (a11) and the olefinically unsaturated carboxylic acids (a112) used for preparing the glycidyl esters (a12) are selected from the group consisting of dicarboxylic and monocarboxylic acids.

4. The mixture of claim 3, wherein the olefinically unsaturated carboxylic acids (a11) and (a121) are monocarboxylic acids.

5. The mixture of claim 1, wherein the olefinically unsaturated carboxylic acids (a11) and (a121) are different from one another.

6. The mixture claim 1, wherein the olefinically unsaturated carboxylic acids (a11) and (a121) are selected from the group consisting of acrylic and methacrylic acids.

7. The mixture of claim 6, wherein the olefinically unsaturated monocarboxylic acid (a121) is methacrylic acid.

8. The mixture as claimed in of claim 6, wherein the olefinically unsaturated monocarboxylic acid (a11) is acrylic acid.

9. The mixture of claim 1, wherein the reaction product (a1), based on its total amount, contains at least 60% by weight of a mixture of 3-acryloyloxy-2-hydroxypropyl methacrylate and 2-acryloyloxy-3-hydroxypropyl methacrylate.

10. The mixture of claim 1, wherein the polyisocyanate (a2) has a mean isocyanate functionality >2 to <6.

11. The mixture of claim 1, wherein the polyisocyanate (a2) comprises one or more isocyanate groups, and at least some of these isocyanate groups have been reacted with the reaction product (a1).

12. The mixture of claim 1, wherein the reaction product (A) comprises at least one reactive functional group selected from the group consisting of free and blocked isocyanate groups.

13. The mixture of claim 1, wherein the rheology control additive (B) is selected from the group consisting of urea derivatives, crosslinked polymeric microparticles, inorganic phyllosilicates, silicas, synthetic polymers containing ionic and/or associative groups, cellulose derivatives, starch derivatives, hydrogenated castor oil, overbasic sulfonates, and associative thickeners based on polyurethane.

14. The mixture of claim 13, wherein the rheology control additive (B) is at least one of the group consisting of
inorganic phyllosilicates (B) selected from the group consisting of aluminum magnesium silicates, sodium magnesium phyllosilicates, and sodium magnesium fluorine lithium phyllosilicates of the montmorillonite type;
silicas (B) selected from the group consisting of nanoscale pyrogenic silicon dioxides and silicon dioxides prepared by means of sol-gel technology;
synthetic polymers (B) selected from the group consisting of polyvinyl alcohol, poly(meth)acrylamide, poly(methacrylic acid), polyvinylpyrrolidone, styrene-maleic anhydride copolymers, ethylene maleic anhydride copolymers and their derivatives, and polyacrylates; and
associative thickeners (B) selected from the group consisting of hydrophobically modified ethoxylated polyurethanes.

15. The mixture of claim 1, comprising at least one further constituent (C).

16. The mixture of claim 15, wherein constituent (C) is selected from the group consisting of binders curable physically, thermally, with actinic radiation, and both thermally and with actinic radiation; crosslinking agents curable thermally and both thermally and with actinic radiation; low molecular mass and oligomeric reactive diluents curable thermally, with actinic radiation, and both thermally and with actinic radiation; and additives other than constituent (B).

17. The mixture of claim 15, wherein the additive (C) is selected from the group consisting of color pigments, effect pigments, or a combination thereof, molecularly dispersely soluble dyes; light stabilizers, such as UV absorbers and reversible free-radical scavengers (HALS); antioxidants; low-boiling and high-boiling (“long”) organic solvents; devolatilizers; wetting agents; emulsifiers; slip additives; polymerization inhibitors; thermal crosslinking catalysts; thermolabile free-radical initiators; adhesion promoters; flow agents; film-forming auxiliaries; flame retardants; corrosion inhibitors; free-flow aids; waxes; siccatives; biocides; and flatting agents.

18. A process for preparing a pseudoplastic curable mixture comprising:
mixing constituents (A) and (B) with one another and homogenizing the resulting mixture provide a pseudoplastic curable mixture, wherein
(A) comprises at least one reaction product comprising the reaction product of (a1) and (a2), wherein
(a1) comprises at least one reaction product comprising the reaction product of components (a11) and (a12), wherein
(a11) comprises at least one olefinically unsaturated carboxylic acid with and
(a12) comprises at least one glycidyl ester of an unsaturated carboxylic acid (a121)
(a2) comprises at least one polyisocyanate having an epoxide group (calculated as M=42 daltons) content <0.2% by weight and an, acid number <10 mg KOH/g; and
(B) comprises at least one rheology control additive.

19. The process claim 18, wherein the pseudoplastic curable mixture is used for producing, or preparing, sheets, moldings, coating materials, adhesives or sealants.

20. The process of claim 19, wherein the coating materials serve for producing single-coat systems, multicoat systems, or a combination thereof.

21. The process of claim 19, wherein the coating materials are electrocoat materials, primer coating materials, clearcoat materials, solid-color topcoat materials, basecoat materials, surfacers or antistonechip primers for producing electrocoats, primer coats, surfacer coats or antistonechip primer coats, basecoats, solid-color topcoats, or clearcoats.

22. The process of claim 19, wherein the moldings, sheets, coating materials, adhesives, or sealants are used for wrapping, packaging, surface-coating, or adhesively bonding and sealing
means of transport, interior and exterior, and parts thereof,
buildings, interior and exterior, and parts thereof,
doors, windows, and furniture, and
in the context of industrial coating, hollow glassware, coils, containers, packaging, small parts, electrical, mechanical or optical components or components for white goods.

23. The mixture of claim 1, wherein the polyisocyanate (a2) comprises one or more isocyanate groups, and all of these isocyanate groups have been reacted with the reaction product (a1).
